(19) United States
(12) Patent Application Publication
(10) Pub. No.: US 2024/0269670 A1
(43) Pub. Date: Aug. 15, 2024

(54) Methods, Systems, and Devices for Linear Electrowetting Cartridges

(71) Applicant: IDEXX LABORATORIES, INC., Westbrook, ME (US)

(72) Inventors: Murthy Yerramilli, Westbrook, ME (US); Jennifer Gagner, Westbrook, ME (US); William Foster, Westbrook, ME (US); Eugene Chan, Westbrook, ME (US); Wayne Bell, Westbrook, ME (US); Asante Malima, Westbrook, ME (US)

(21) Appl. No.: 18/434,614

(22) Filed: Feb. 6, 2024

Related U.S. Application Data
(60) Provisional application No. 63/484,433, filed on Feb. 10, 2023.

(51) Int. Cl. B01L 3/00

(52) U.S. Cl. CPC B01L 3/502715; B01L 3/50273; B01L 3/502746; B01L 3/502761; B01L 2200/027; B01L 2200/04; B01L 2200/0647; B01L 2200/0689; B01L 2300/0654; B01L 2300/0819; B01L 2300/0864; B01L 2300/123; B01L 2300/18; B01L 2400/0409; B01L 2400/0442

(57) ABSTRACT

A method for preparing analyzing a droplet on a surface of a cartridge, wherein the droplet comprises a plurality of particles is disclosed. The method includes transporting, via a plurality of electrodes of the cartridge, the droplet along a single path on the surface of the cartridge, wherein the single path is substantially linear and the plurality of electrodes is configured to transport the droplet along the single path on the surface of the cartridge. The method also includes analyzing the droplet at one or more locations along the single path on the surface of the cartridge.

### FIELD OF THE DISCLOSURE

The present disclosure involves systems and methods for analyzing a droplet comprising a plurality of particles a defined path on the surface of the cartridge. Namely, devices and methods of the disclosure transport the droplet on a defined path (e.g., a single, substantially linear path) on a surface of the cartridge and analyze the droplet to identify a parameter (e.g., a unique identifying feature) of the droplet and/or a component thereof (e.g., at least one paramagnetic, bar-coded bead).

### BACKGROUND

Assays (including immunoassays) and other analytical evaluations (e.g., polymerase chain reaction (PCR) tests) can be conducted on one or more portions of a sample utilizing a variety of different methods, including by utilizing a plurality of particles (e.g., paramagnetic, bar-coded beads) and other components of a droplet of the solution containing the sample to assist in performing the assays and other analytical evaluations.

### SUMMARY

In some examples, a plurality of particles (e.g., paramagnetic, bar-coded beads), can be suspended within a solution that can be used for testing and identification of components in the solution and/or a portion thereof (e.g., a droplet of the solution). To increase the accuracy and speed of the test results, it is desirable to, prior to testing, ensure that the plurality of particles are correctly dispersed throughout the solution and properly mixed and analyzed during the testing protocol (e.g., an assay).

When operators manually prepare the solution for testing, the homogeneity and number of particles throughout the prepared solution may be inconsistent and/or inaccurate. Further, if the operator allows too much time to elapse between manually preparing (e.g., stirring) the solution and withdrawing a sample therefrom, the particles may become less homogenized throughout the solution (e.g., by settling to the bottom of a container, clumping together or both, among other potential issues), which in turn can also impact the accuracy and precision of any test results for which the solution may be used. Accordingly, manual preparations of the solution are subject to variability between preparations and/or operators and, thus, degrade the accuracy and precision of any associated test results.

In an example, a method is described for analyzing a droplet on a surface of a cartridge, wherein the droplet comprises a plurality of particles. The method comprises transporting, via a plurality of electrodes of the cartridge, the droplet along a single path on the surface of the cartridge, wherein the single path is substantially linear and the plurality of electrodes is configured to transport the droplet along the single path on the surface of the cartridge and analyzing the droplet at one or more locations along the single path on the surface of the cartridge.

In another example, a non-transitory computer-readable medium is described, having stored thereon program instructions that, upon execution by a controller cause a controller to perform a set of operations. The set of operations comprises transporting, via a plurality of electrodes of a cartridge, a droplet along a single path on a surface of the cartridge, wherein the droplet comprises a plurality of particle, and wherein the single path is substantially linear and the plurality of electrodes is configured to transport the droplet along the single path on the surface of the cartridge and analyzing the droplet at one or more locations along the single path on the surface of the cartridge.

The features, functions, and advantages that have been discussed can be achieved independently in various examples or may be combined in yet other examples. Further details of the examples can be seen with reference to the following description and drawings.

### BRIEF DESCRIPTION OF THE FIGURES

The above, as well as additional features will be better understood through the following illustrative and non-limiting detailed description of example embodiments, with reference to the appended drawings.

FIG. 1 illustrates a simplified block diagram of an example computing device, according to an example embodiment.

FIG. 2 illustrates a cartridge, according to an example embodiment.

FIG. 3 illustrates a cartridge, according to an example embodiment.

FIG. 4 illustrates a cartridge, according to an example embodiment.

FIG. 5 illustrates a method, according to an example embodiment.

All the figures are schematic, not necessarily to scale, and generally only show parts which are necessary to elucidate example embodiments, wherein other parts may be omitted or merely suggested.

### DETAILED DESCRIPTION

Example embodiments will now be described more fully hereinafter with reference to the accompanying drawings. That which is encompassed by the claims may, however, be embodied in many different forms and should not be construed as limited to the embodiments set forth herein; rather, these embodiments are provided by way of example. Furthermore, like numbers refer to the same or similar elements or components throughout.

Within examples, the disclosure is directed to devices and methods for manipulating droplets of a solution containing samples and a plurality of particles (e.g., one or more types of paramagnetic, bar-coded beads) containing one or more identifying features (such as a unique bar code, a color, a shape, an alphanumeric symbol, and/or the like). These particles include one or more of the following: microbeads, microparticles, micropellets, microwafers, microparticles containing one or more identifying features (such as a bar code, a color, a shape, an alphanumeric symbol, and/or the like), paramagnetic microparticles, paramagnetic microparticles containing one or more bar codes, and/or beads containing one or more nickel bar codes. Moreover, the particles may be magnetic or paramagnetic. Particles suitable for use in the disclosure are capable of attachment to other substances such as derivatives, linker molecules, proteins, nucleic acids, or combinations thereof. The capability of the particles to be attached to other substances can result from the particle material as well as from any further surface modifications or functionalization of the particle. The particles can be functionalized or be capable of becoming functionalized in order to covalently or non-covalently attach proteins, nucleic acids, linker molecules or derivatives as described herein.

For example, the surface of these particles (e.g., paramagnetic, bar-coded beads), can be modified or functionalized with amine, biotin, streptavidin, avidin, protein A, sulfhydryl, hydroxyl and carboxyl. These particles may be spherical or other shapes, may be light transmissive and may be digitally coded such as for example, by an image that provides for high contrast and high signal-to-noise optical detection to facilitate identification of the bead. To the extent an image is present, the image may be implemented by a physical structure having a pattern that is partially substantially transmissive (e.g., transparent, translucent, and/or pervious to light), and partially substantially opaque (e.g., reflective and/or absorptive to light) to light. The pattern of transmitted light is determined (e.g., by scanning or imaging), and the code represented by the image on the coded bead can be decoded. Various code patterns, such as circular, square, or other geometrical shapes, can be designed as long as they can be recognized by an optical decoder. Examples of these one or more types of particles may be found at: U.S. Pat. Nos. 7,745,091, 8,148,139, and 8,614,852.

Additionally or alternatively, these particles (e.g., paramagnetic, bar-coded beads) may comprise one or more materials, including one or more of the following: glass, polymers, polystyrene, latex, elemental metals, ceramics, metal composites, metal alloys, silicon, or of other support materials such as agarose, ceramics, glass, quartz, polyacrylamides, polymethyl methacrylates, carboxylate modified latex, melamine, and Sepharose, and/or one or more hybrids thereof. In particular, useful commercially available materials include carboxylate modified latex, cyanogen bromide activated Sepharose beads, fused silica particles, isothiocyanate glass, polystyrene, and carboxylate monodisperse microspheres. Furthermore, these particles also comprise one or more specific shapes, dimensions, and/or configurations and may be modified for one or more specific uses. For example, theses particles (e.g., paramagnetic, bar-coded beads) may be a variety of sizes from about 0.1 microns to about 100 microns, for example about 0.1, 0.5, 1.0, 5, 10, 20, 30, 40 50, 60, 70, 80 90 or 100 microns. In a further aspect, these particles may be surface modified and/or functionalized with biomolecules for use in biochemical analysis.

The particles of the disclosure may be used in various homogenous, sandwich, competitive, or non-competitive assay formats to generate a signal that is related to the presence or amount of an analyte in a test sample. The term “analyte,” as used herein, generally refers to the substance, or set of substances in a sample that are detected and/or measured, either directly or indirectly. In various aspects the assays of the disclosure, examples include sandwich immunoassays that capture an analyte in a sample between a first binding member (e.g., antibody) attached to the particles and a second binding member for the analyte that is associated with a label. In another example embodiment, the binding member on the particles may be an antigen (e.g., protein) that binds an antibody of interest in a patient sample in order to capture the antibody on the particle. The presence of the antibody can then be detected with a label conjugated to a second binding member specific for an antibody. The second binding member attached to the label may be the antigen conjugated to the label or the binding member may itself be an antibody (e.g., anti-species antibody) that is conjugated the label. In example embodiments, these characteristics may be referred to herein as a “unique identifying feature” and/or “parameter” of the particles and/or of droplet in which the particles reside. Other examples are possible. For example, the particles may also bind to a fluorescent tag or label, which may present a “unique identifying feature” and/or “parameter” of particles to which the fluorescent tag or label might bind under a fluorescent and/or ultraviolet lighting.

In another example embodiment, the testing protocols of the disclosure are assays, including competitive immunoassays for detection of antibody in the sample. A competitive immunoassay may be carried out in the following illustrative manner. A sample, from an animal's body fluid, potentially containing an antibody of interest that is specific for an antigen, is contacted with the antigen attached to the particles and with the anti-antigen antibody conjugated to a detectable label. The antibody of interest, present in the sample, competes with the antibody conjugated to a detectable label for binding with the antigen attached to the particles. The amount of the label associated with the particles can then be determined after separating unbound antibody and the label. The signal obtained is inversely related to the amount of antibody of interest present in the sample.

In an alternative example embodiment of a competitive a sample, an animal's body fluid, potentially containing an analyte, is contacted with the analyte conjugated to a detectable label and with an anti-analyte antibody attached to the particles. The antigen in the sample competes with analyte conjugated to the label for binding to the antibody attached the particles. The amount of the label associated with particles can then be determined after separating unbound antigen and label. The signal obtained is inversely related to the amount of analyte present in the sample.

Antibodies, antigens, and other binding members may be attached to the particles or to the label directly via covalent binding with or without a linker or may be attached through a separate pair of binding members as is well known (e.g., biotin:streptavidin, digoxigenin:anti-digoxiginen). In addition, while the examples herein reflect the use of immunoassays, the paramagnetic, bar-coded beads and/or particles and methods of the disclosure may be used in other receptor binding assays, including nucleic acid hybridization assays that rely on immobilization of one or more assay components to a solid phase.

Testing protocols, including assays, using these solutions are often conducted over a series of agitation events. In practice, the particles (e.g., paramagnetic, bar-coded beads) in the solution may bind together (often referred to as “clumping”) or bind and/or settle on the bottom or sides of a container. This binding may result in an inconsistent dispersion of particles in the solution, if these particles clump together, they may not be accurately identified or accounted for in the testing protocol (e.g., an assay).

In other examples, after one or more binding members have attached to the particles, the solution surrounding the paramagnetic, bar-coded beads and/or particles may be removed from the container (e.g., a cartridge) and the particles with attached binding members (collectively referred to herein as “assembled beads”) may be washed in preparation for testing. In an example embodiment, during this washing portion, one or more components may be used to facilitate the washing, including one or more components of a cartridge to secure the assembled particles in one or more portions of the cartridge. For example, if the assembled beads have magnetic or paramagnetic properties (e.g., if they contain paramagnetic, bar-coded beads), a magnet may be used to secure the assembled beads in a portion of the cartridge while a washing solution is dispersed into the cartridge to improve the results of the washing portion (e.g., by ensuring that the assembled beads remain intact and in a specific portion of the cartridge). Other improvements may be realized.

For example, to help address these issues, the cartridge may be utilize a plurality of electrodes that facilitate transportation of individual droplets of a liquid on a surface of the cartridge. To do so, in one example embodiment, the cartridge surface may comprise a dielectric materials and transport the individual droplets along one or more paths defined by the plurality of electrodes on a printed circuit board (PCB). Such techniques are often referred to as electrowetting on dielectric (“EWOD”). In example embodiments, the dielectric materials may comprise a hydrophobic material, layer, and/or coating disposed on the surface of the PCB and/or plurality of electrodes, the combination of which is referred to herein as the “dielectric cartridge surface” and/or a “path” or “paths” along the dielectric cartridge surface.

To date, such cartridges have involved a complicated, interwoven series of paths along the dielectric cartridge surface. Due to a number of factors, including the manufacturing costs of such cartridges, there exists a need to optimize cartridges to be able to execute various steps of testing protocols, but not include components that are extraneous to the desired testing protocols. Further, the more complicated the configuration of the cartridge and/or the fluidic paths on the surface of the cartridge, the more distance and component interaction with the fluid that travels along these paths are required. This complication adds cost, time, and even potential error to one or more parts of the testing protocol. Thus, there exists a need for a direct path for transporting a droplet on a surface of the cartridge, including, in some embodiments, a single, substantially linear path with a plurality of electrodes configured to transport a droplet along the single path on the surface of the cartridge.

Disclosed herein are devices, systems, and methods for a linear path cartridge for use in EWOD systems and applications to perform one or more testing protocols (e.g., assays) using one or more particles and particle types (e.g., paramagnetic bar-coded beads). In example embodiments, by allowing bi-directional flow along a single, substantially linear path on the surface of the cartridge, particle assembly, sample analysis, and associated testing protocols are improved.

In some embodiments, transportation of the droplets on the cartridge surface can be controlled by a controller and/or other computing devices to create a programmable fluidic path which can be used in number of ways (e.g., to facilitate the performance of an assay and/or immunoassay). Further, because the fluidic movements of the droplets are controlled by a controller and/or other computing device, and programmable, assay protocols and subparts thereof can be finely controlled to meet the needs of the desired testing protocol (e.g., an assay).

In some embodiments, it is beneficial to immobilize the droplet and/or components thereof (e.g., paramagnetic, bar-coded beads) for one or more steps in a testing protocol (e.g., and assay). In some embodiments, immobilization of the droplets on the cartridge surface can be controlled by the at least one magnet. In some example embodiments, the at least one magnet may be a permanent or semi-permanent magnet below or above one or more portions of the cartridge surface. In other embodiments, the at least one magnet may be an electric magnet configured to interact with the droplet and/or components thereof (e.g., paramagnetic, bar-coded beads) via a controller and/or other computing devices to create a programmable interaction along the fluidic path to promote assay protocols and subparts thereof.

In some embodiments, it is beneficial to protect or otherwise shield the droplet, components thereof (e.g., paramagnetic, bar-coded beads), and/or other materials residing on the surface of the cartridge for one or more steps in an assay. To do so, in some embodiments, the cartridge may be covered by one more materials that protect the components residing on the surface of the cartridge, but still leave enough space on the cartridge surface for the droplet, components thereof (e.g., paramagnetic, bar-coded beads), and/or other assay components to be transported and/or immobilized on the cartridge surface. In some example embodiments, this protective layer may be made of plastic and/or other materials that do interact with the droplet and/or components thereof (e.g., paramagnetic, bar-coded beads), magnets, electrodes, or any other controller and/or other computing devices during the assay protocols and subparts thereof.

In some embodiments, the fluidic manipulation of the droplets components thereof on the cartridge surface can be promoted by materials other magnets and/or electrodes and/or the controller and other computing devices that control the same. In some embodiments, to improve fluidic transportation and/or immobilization of the droplet on the dielectric surface of the cartridge, one or more oils may be introduced on the surface of the cartridge, which can be used in number of ways (e.g., to improve the fluidic transportation of the droplet during the assay and/or immunoassay). Other examples are possible.

In an example embodiment, in addition to manipulating (e.g., transporting and/or immobilizing) the droplet on the surface of the cartridge, various antibodies, antigens, and/or other components may also be controlled, mixed, transported, and/or immobilized on the surface of the cartridge. Using this programmable protocol, antibodies, antigens, and/or other components may be adhered onto one or more surfaces of paramagnetic, bar-coded beads (the “assembled beads”). In a further aspect, one or more analyses may be performed on the assembled beads (or other particles) on the surface of the cartridge. In this regard, a user of the cartridge can perform complicated, often multi-step protocols, which are often spread over several machines and devices at various stages of the multi-step protocols, in a single cartridge and a single instrument/device. In one example embodiment, a multiplex multiple analyte targets in a single reaction may be performed on a droplet on the surface of the cartridge detailed above, instead of using multiple devices (e.g., shaker plates, pipettes, vials, plates with multiple wells, plate readers, cameras, etc.). In one example embodiment, a multiplex multiple analyte targets in a single reaction may be performed on a droplet in a portion of the surface of the cartridge comprising a single electrode.

In this regard, by combining the cartridge, EWOD, magnetic, and paramagnetic, bar-coded bead technologies, the concepts described herein provide disclosure for a compact, in clinic, instrument with multiplex capability. In an example embodiment, by leveraging these technologies, a platform is described that can have the same convenience as other tabletop devices (e.g., a SNAPR reader and device) but with the increased menu of capabilities for laboratory testing and assay protocols, including multi-part assays (e.g., multiplex, Mpx lab tests), without the inconvenience and costs of the devices, instruments, and operators typically required for these tests and assays (e.g., liquid handling robots, plates, plate washers, and/or specialized plate readers). Further, in example embodiments, because multiple tests and assays may be completed on one or more small sample sizes (e.g., one or more droplets containing assembled paramagnetic, bar-coded beads), the present disclosure allows complex analysis (e.g., of multiple analytes) based on small volumes of samples, which is beneficial in instances where sample volume is an issue.

In one example, a user may add a sample (e.g., a fecal sample, urine sample, blood sample, etc.) into a reservoir of the cartridge, insert a cartridge into a tabletop instrument/device, and allow the instrument/device to add and/or control other components (e.g., paramagnetic, bar-coded beads, solution, antibodies, etc.) on the cartridge, and analyze one or more components to provide one or more results to clinician, physician, and/or patient based on the same, all using the same sample, cartridge and instrument/device. Importantly, once the user inserts the cartridge into the tabletop instrument device, some (or all) of the fluidics, manipulation of the components in the cartridge (including the paramagnetic, bar-coded beads), and eventual reading of these components are all automated, controlled, and finely-tuned by program instructions executing on a computing device, all of which may be accomplish without user interaction or control.

By doing so, several benefits are realized, including users (e.g., clinicians) having the same high throughput/multiplexing capability of the traditional bead technologies without the required overhead of user controlling or coordinating every step of the process or the multitude of separate devices and components required to accomplish the tests and/or assays. Time to result would also be improved, instead of sending samples to a lab and waiting for a prolonged period of time for results (sometimes several days), users could have results in a matter of minutes, and all while using a single sample on a single cartridge in connection with a single device. This improved time to result also improves the ability for a treating physician and/or patient to receive results in a more timely manner (e.g., results could be shared with the patient during the visit) and make more timely decisions based thereon.

In a further aspect, by allowing bi-directional flow along a single, substantially linear path on the surface of the cartridge, results from sample interaction with the particles that are used in the testing protocols are also improved. In one example, particles (including paramagnetic, bar-coded beads) may be immobilized along one or more portions of the path on the cartridge surface and a sample or samples may be transported along the path and interact with the particles more than once, potentially at different stages of the testing protocol. In this regard, sample analysis and associated testing protocols are improved as particle/sample interactions are increased. In example, with increased particle/sample interaction, any associated particle assembly and/or associated readings/imaging/analysis are also improved.

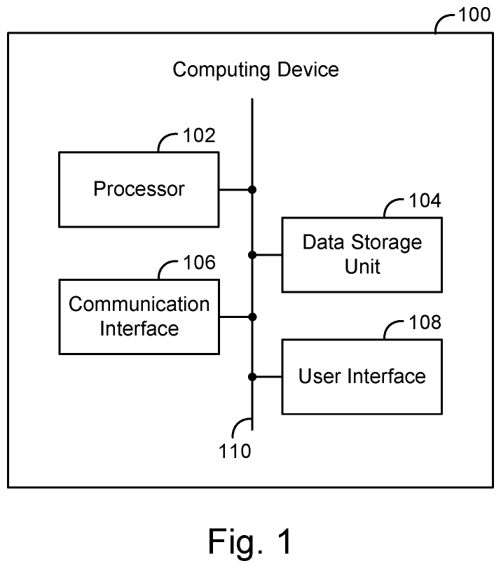

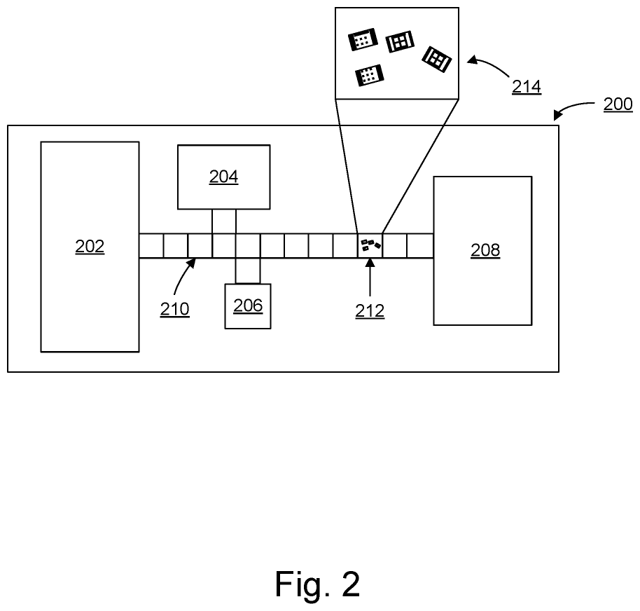

Referring now to the figures, FIG. 1 is a simplified block diagram of an example computing device 100 of a system (e.g., those illustrated in FIG. 2, described in further detail below). Computing device 100 can perform various acts and/or functions, such as those described in this disclosure. Computing device 100 can include various components, such as processor 102, data storage unit 104, communication interface 106, and/or user interface 108. These components can be connected to each other (or to another device, system, or other entity) via connection mechanism 110.

Processor 102 can include a general-purpose processor (e.g., a microprocessor) and/or a special-purpose processor (e.g., a digital signal processor (DSP)).

Data storage unit 104 can include one or more volatile, non-volatile, removable, and/or non-removable storage components, such as magnetic, optical, or flash storage, and/or can be integrated in whole or in part with processor 102. Further, data storage unit 104 can take the form of a non-transitory computer-readable storage medium, having stored thereon program instructions (e.g., compiled or non-compiled program logic and/or machine code) that, when executed by processor 102, cause computing device 100 to perform one or more acts and/or functions, such as those described in this disclosure. As such, computing device 100 can be configured to perform one or more acts and/or functions, such as those described in this disclosure. Such program instructions can define and/or be part of a discrete software application. In some instances, computing device 100 can execute program instructions in response to receiving an input, such as from communication interface 106 and/or user interface 108. Data storage unit 104 can also store other types of data, such as those types described in this disclosure.

Communication interface 106 can allow computing device 100 to connect to and/or communicate with another other entity according to one or more protocols. In one example, communication interface 106 can be a wired interface, such as an Ethernet interface or a high-definition serial-digital-interface (HD-SDI). In another example, communication interface 106 can be a wireless interface, such as a cellular or WI FI interface. In this disclosure, a connection can be a direct connection or an indirect connection, the latter being a connection that passes through and/or traverses one or more entities, such as such as a router, switcher, or other network device. Likewise, in this disclosure, a transmission can be a direct transmission or an indirect transmission.

User interface 108 can facilitate interaction between computing device 100 and a user of computing device 100, if applicable. As such, user interface 108 can include input components such as a keyboard, a keypad, a mouse, a touch sensitive panel, a microphone, a camera, and/or a movement sensor, all of which can be used to obtain data indicative of an environment of computing device 100, and/or output components such as a display device (which, for example, can be combined with a touch sensitive panel), a sound speaker, and/or a haptic feedback system. More generally, user interface 108 can include hardware and/or software components that facilitate interaction between computing device 100 and the user of the computing device 100.

Computing device 100 can take various forms, such as a workstation terminal, a desktop computer, a laptop, a tablet, a mobile phone, or a controller.

Now referring to FIG. 2, a cartridge 200 is disclosed, which includes a sample reservoir 202, a solution reservoir 204, an assay component reservoir 206, and a waste reservoir 208, all of which reside on the dielectric cartridge surface, according to an example embodiment. In this example embodiment, a plurality of electrodes and at least one magnet are disposed along various portions of dielectric cartridge surface, including along the single substantially linear path 210 that extends between sample reservoir 202 and waste reservoir 208, and is connected to the paths on the dielectric cartridge surface that lead to solution reservoir 204 and assay component reservoir 206. In a further aspect, the plurality of electrodes and at least one magnet may be disposed under and/or around any of the illustrated sample reservoir 202, solution reservoir 204, assay component reservoir 206, waste reservoir 208, and/or portion 212.

As noted above, this plurality of electrodes along the illustrated paths and reservoirs on the dielectric cartridge surface facilitates transportation of a fluid droplet containing a plurality of particles (e.g., at least one paramagnetic, bar-coded bead) along the single substantially linear path 210 of dielectric cartridge surface. For clarity, as illustrated in FIG. 2, the term “dielectric cartridge surface” as used in FIG. 2 includes the cartridge surfaces below the illustrated sample reservoir 202, solution reservoir 204, assay component reservoir 206, and waste reservoir 208, as well as all of the illustrated paths that connect all of these components in FIG. 2.

In examples, the cartridge 200 and/or any components thereof may interact with a computing device, such as computing device 100. As described above, a computing device 100 can be implemented as a controller, and a user of the controller can use the controller to program and/or control cartridge 200 and/or any components thereof. The cartridge 200 and/or any components thereof may communicably coupled with a controller, such as computing device 100, and may communicate with the controller by way of a wired connection, a wireless connection, or a combination thereof. Further, as described above, a controller may be configured to control various aspects of the illustrated cartridge 200 and testing protocols (e.g., assays) utilizing cartridge 200 and/or any components thereof. Although various cartridge components and arrangements of these components a are provided for explanatory purposes, and different shapes, amounts, and/or types of beads, particles, and/or components may be used.

In examples, the controller can execute a program that cause one or more components of the cartridge 200 to perform a series of events to by way of a non-transitory computer-readable medium having stored program instructions. These program instructions include, for example, applying voltage and/or current to a plurality of electrodes near (e.g., below) the dielectric materials of dielectric cartridge surface to transport one or more droplets (or components thereof) along the dielectric cartridge surface. In some examples, the plurality of electrodes may be used to transport one or more droplets between the illustrated components of FIG. 2 and/or manipulate the one or more droplets and/or components thereof at one more portions of the dielectric cartridge surface. For example, controller may apply a direct current to the plurality of electrodes in a succession of on/off voltage/current bursts, which may result in the droplet alternating between an elongated form on the dielectric surface (when the voltage/current is applied to an electrode near the droplet) and a non-elongated form on the dielectric surface (when the voltage/current is not applied to an electrode near the droplet). In examples, this oscillation of on/off voltage/current bursts and the associated form the droplet takes during each event, may be useful for mixing the components within the droplet. Certain voltages/currents amplitudes and patterns, as well as electrode placement around the surface of the dielectric cartridge surface may more effectively agitate the droplet to produce more accurate and consistent particle mixing and associated test results than other methods.

For example, if a direct current is applied to electrodes proximate to droplet containing paramagnetic, bar-coded beads, because of the paramagnetic properties of the beads, the beads may align with the direct current and stay stationary on the surface of the dielectric cartridge surface. Alternatively, if an alternating current is applied to electrodes proximate to droplet containing paramagnetic, bar-coded beads, because of the paramagnetic properties of the beads, the beads may align with the direct current and alternate between two or more positions on the surface of the dielectric cartridge surface based on the alternating current. Other examples are possible and it should be appreciated that complex and novel fluidic functions can be performed because of the processor-controlled fluidics.

For example, the controller program instructions can include moving various fluids around the surface of the cartridge and perform various aspects of a testing protocol (e.g., assay), all on the surface of the cartridge and all in an automated (or largely automated) procedure.

In this regard, in example embodiments, the plurality of electrodes may transport a droplet containing paramagnetic, bar-coded beads along the single substantially linear path 210 of dielectric cartridge surface. In examples, the paramagnetic, bar-coded beads may be introduced into a droplet, either in a liquid suspension or dried onto a surface of the cartridge 200 and rehydrated. In one example, the paramagnetic, bar-coded beads may be suspended in buffer solution containing sucrose, removed from the suspension, and dried before being stored on a portion 212 of the single substantially linear path 210 of dielectric cartridge surface. In examples, the dried paramagnetic, bar-coded beads may be rehydrated with one or more solutions containing one or more components (e.g., reagents, sample, or both, among other possibilities) before being used in one or more aspects of a testing protocol (e.g., an assay). In example embodiments, once the paramagnetic, bar-coded beads are rehydrated and/or introduced into a fluidic droplet, the droplet containing paramagnetic, bar-coded beads may be transported from portion 212 to sample reservoir 202 to be mixed with a sample residing in sample reservoir (e.g., a fecal sample, urine sample, blood sample, etc.).

In other example embodiments, the dried paramagnetic, bar-coded beads may be stored in the sample reservoir 202 and rehydrated with solution from solution reservoir 204, liquid that accompanies the sample upon introduction to sample reservoir 202 (e.g., urine), or both, among other possibilities.

In a further aspect, in example embodiments, the plurality of electrodes may transport a droplet of assay components (e.g., containing antibodies, antigens, labels, reagents, and/or other binding members) from assay component reservoir 206 on the dielectric cartridge surface. In examples, these assay components may be introduced into a droplet, either in a liquid suspension or dried onto a surface of the cartridge 200 and rehydrated (e.g., in component reservoir 206, on the path approximate to component reservoir 206, or both, among other possibilities). Either way, once the assay components are introduced into the droplet, the droplet containing assay components may be transported to sample reservoir 202 to be mixed with the sample and/or paramagnetic, bar-coded beads residing in sample reservoir.

In other example embodiments, one or more particular assay components (e.g., antibodies) may be dried and stored in the sample reservoir 202, perhaps with the dried paramagnetic, bar-coded beads, and rehydrated in the sample reservoir with solution from solution reservoir 204, liquid that accompanies the sample upon introduction to sample reservoir 202 (e.g., urine), or both, among other possibilities. In a further aspect, in this example embodiment, one or more additional assay components (e.g., reagents, fluorescent labels/tags, etc.) may be stored assay component reservoir 206 and transported on the dielectric cartridge surface to the sample reservoir 202 to be mixed with the one or more particular assay components, paramagnetic, bar-coded beads, and/or sample.

Furthermore, although sample reservoir 202, solution reservoir 204, and assay component reservoir 208 are illustrated as single reservoirs in FIG. 2, it should be apparent to a person of ordinary skill in the art that any, some, or all of these reservoirs may comprise multiple, separate reservoirs, each of which may contain a particular particle, components, or combination thereof (e.g., dried paramagnetic, bar-coded beads and/or particular antibodies, antigens, labels, and/or other binding members). Additionally or alternatively, although specifically illustrated in FIG. 2, there may be multiple assay component reservoirs in cartridge 200, each with their own associated assay component and/or path on the dielectric cartridge surface.

In example embodiments, a variety of techniques can be used facilitate the mixing of the sample, the paramagnetic, bar-coded beads, and the assay components in the sample reservoir 202. In some examples, a plurality of electrodes disposed near the sample reservoir 202 may be employed to circulate and/or otherwise manipulate the fluidics of the components in the sample reservoir 202, including the droplet containing paramagnetic, bar-coded beads, the sample (which may contain liquids), the assay components, and/or combinations thereof, among other possibilities.

For example, one or more magnets disposed near the sample reservoir 202 may be employed to immobilize the droplet containing paramagnetic, bar-coded beads, while the plurality of electrodes can be used in connection with the magnets to otherwise manipulate the fluidics of the other components in the sample reservoir 202, including the droplet containing paramagnetic, bar-coded beads, the sample (which may contain liquids), the assay components, and/or combination thereof, among other possibilities. For example, one or more mixing beads may also reside in the sample reservoir 202, which may be controlled by the magnets, the electrodes, or both to further facilitate mixing the components in the sample reservoir 202 at various mixing speeds, patterns, etc., all of which may be controlled by the controller executing program instructions controlling the components of the cartridge 200.

In example embodiments, once the droplet containing paramagnetic, bar-coded beads, the sample, and/or other assay components is sufficiently mixed, all of these components may incubate in the sample reservoir 202 (e.g., to allow attachment of one or more assay components and/or components of the sample to attach to the paramagnetic, bar-coded beads). In example embodiments, once the incubation is complete, the paramagnetic, bar-coded beads and the attached sample and/or assay components (collectively, the “assembled beads”) may be immobilized in the sample reservoir 202 (e.g., using a magnet) while the fluids in the sample reservoir 202 may be transported to waste reservoir 208 along the single substantially linear path 210 of dielectric cartridge surface (e.g., using a plurality of electrodes).

After the fluids are removed from the sample reservoir 202, a solution (e.g., a washing solution) may be transported from solution reservoir 204 to sample reservoir 202 to wash excess debris and/or other components from the assembled beads contained in sample reservoir 202. In example embodiments, this solution may interact with the assembled beads based on fluidics controlled by the plurality of electrodes transporting the solution fluid over immobilized assembled beads, or via a mixing protocol with the assembled beads (such as the mixing steps described above). Once the excess debris and/or other components are washed from the assembled beads, the solution (and any other excess fluids) may be transported from sample reservoir 202 to waste reservoir 208 along dielectric cartridge surface (e.g., using a plurality of electrodes), as the assembled beads remain in the sample reservoir 202 (e.g., via immobilization).

In other examples, this sequence of transporting the paramagnetic, bar-coded beads and/or the assembly components to the sample reservoir, mixing in the sample reservoir, and transporting solution to and from to the sample reservoir may be repeated a number of times and/or in different orders, depending on the requirements of the testing protocol.

For example, a first assembly component (e.g., a detection antibody) may be stored in the sample reservoir 202 and mixed with the paramagnetic, bar-coded beads and sample, all of which may be allowed to incubate in the sample reservoir 202. Then, after washing the first assembly component, paramagnetic, bar-coded beads, and sample mix (e.g., with solution from the solution reservoir 204), a second assembly component (e.g., a streptavidin reagent) stored in the assay component reservoir 206 may be transported into the sample reservoir 202 to complete another portion of the assembly protocol for the assembled beads, before the assembled beads are analyzed.

In examples, once the assembled beads are completed and ready for analysis, the assembled beads may be transported along single substantially linear path 210 of dielectric cartridge surface to a portion 212 of the single substantially linear path 210 for analysis. In example embodiments, the assembled beads may be transported via fluidic transportation from the sample reservoir 202 along the single substantially linear path 210 of dielectric cartridge surface using the plurality of electrodes, at least one magnet (i.e., moving the paramagnetic beads across the across the dielectric cartridge surface based on interaction with one or more magnets), or both, among other possibilities.

In examples, portion 212 of the single substantially linear path 210 of dielectric cartridge surface provides a predetermined location for a reader to conduct the testing (e.g., assay) on the assembled bead. In example embodiments, the reader may detect, shortly after the assembled bead is complete, an assay read signal corresponding to at least one of the assembled beads residing on the portion 212 (and potentially immobilized on the portion by one or more magnets). In some example embodiments, this detection may occur within a predetermined time period after assembly is complete and by starting the assay read shortly after the conclusion of the assembly, the assay provides a more accurate result. In an example embodiment, an optics system reader may be employed to decode the individual bar codes of the paramagnetic, bar-coded beads. In other examples, a plurality of electrodes and/or one or more magnets may be used to manipulate the paramagnetic, bar-coded beads while reading other parameters of the droplet containing the assembled beads and/or the assembled beads themselves (e.g., by applying an ultraviolet light and reading the fluorescence of the assembled beads via a fluorophore detector). As illustrated in FIG. 2, exploded view 214 provides an example view of paramagnetic, bar-coded beads being read at the portion 212, and it should be appreciated that this analysis (e.g., reading) could occur at other portions of the cartridge 200, including in the sample reservoir 202.

In a further aspect, although the mixing and analysis protocols have been discussed in connection with sample reservoir 202, it should be appreciated that these mixing protocols can occur in other parts of the illustrated cartridge 200, including on the portion 212 of the single substantially linear path 210 of dielectric cartridge surface. Other examples are possible.

For example, a first assembly component (e.g., a detection antibody) may be stored in the sample reservoir 202 and mixed with the sample in the sample reservoir 202. Then, after mixing the first assembly component and the sample, a droplet of the first assembly component/sample mix may be washed and transported along the single substantially linear path 210 of dielectric cartridge surface to a portion 212 of the single substantially linear path 210 to mix with the paramagnetic, bar-coded beads stored on the portion 212. In this example, the paramagnetic, bar-coded beads stored on the portion 212 may be mixed with the first assembly component/sample mix (e.g., using the mixing protocols described above), and the paramagnetic, bar-coded beads/first assembly component/sample mix may be allowed to incubate on the portion 212. Then, after washing the paramagnetic, bar-coded beads/first assembly component/sample mix (e.g., with solution from the solution reservoir 204), a second assembly component (e.g., a streptavidin reagent) stored in the assay component reservoir 206 may be transported to the portion 212 to mix with the paramagnetic, bar-coded beads/first assembly component/sample mix to complete another portion of the assembly protocol for the assembled beads, before the assembled beads are analyzed. In a further aspect, in this example, because the mixing, incubation, washing, and/or other protocols occur at the portion 212 of the single substantially linear path 210, specific transportation of the assembled beads to this portion 212 is not required, as the assembled beads already reside at this portion 212. In examples, the immobilization and/or other manipulation imparted to the droplet containing the assembled beads, the assembled beads themselves, and/or other components on the portion 212 during analysis may be effectuated using the plurality of electrodes, at least one magnet, or both, among other possibilities.

In a further aspect, as detailed in FIG. 2, by allowing bi-directional flow along a single, substantially linear path on the surface of the cartridge, sample analysis and associated testing protocols are improved based on, at least, improved time to analysis and multiple interactions between the sample and the beads during assembly based on the flow of components and/or the sample over the beads along the single, substantially linear path on the surface of the cartridge.

Additionally, in some example embodiments, the one or more components of the cartridge illustrated in FIG. 2, the controller illustrated in FIGS. 1 and 2, and/or other components of the illustrated system may provide feedback to a user/operator, including a graphical representation of a detected parameter, a test result, and/or the like, via a user interface of the controller and/or the tabletop device to provide information to the user. Other examples are possible.

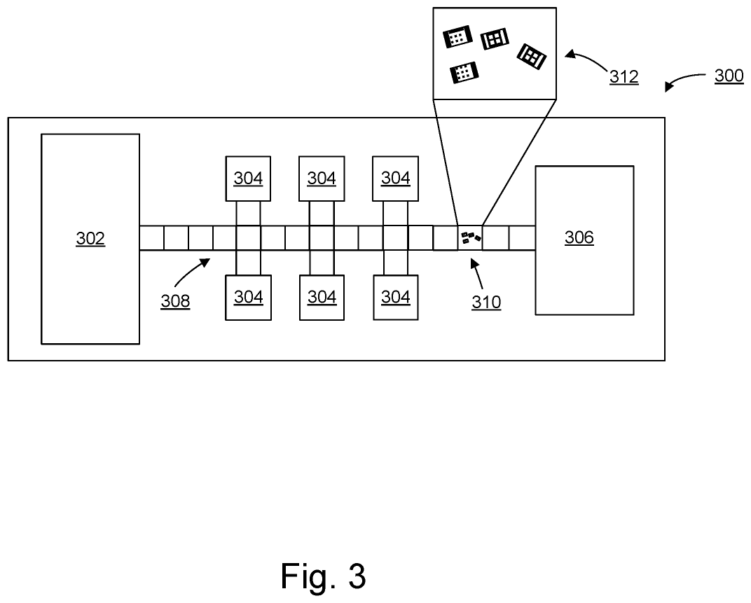

For example, now referring to FIG. 3, a cartridge 300 is disclosed, which includes a sample reservoir 302, multiple component reservoirs 304, and a waste reservoir 306, all of which reside on the dielectric cartridge surface, according to an example embodiment. In this example embodiment, a plurality of electrodes and at least one magnet are disposed along various portions of dielectric cartridge surface, including along the single substantially linear path 308 that extends between sample reservoir 302 and waste reservoir 306, and is connected to the paths on the dielectric cartridge surface that lead to component reservoirs 304. In a further aspect, the plurality of electrodes and at least one magnet may be disposed under and/or around any of the illustrated sample reservoir 302, component reservoirs 304, waste reservoir 306, and/or portion 310.

In examples, the cartridge 300 and/or any components thereof may interact with a computing device, such as computing device 100, which may be implemented as a controller, and a user of the controller can use the controller to program and/or control cartridge 300 and/or any components thereof. Further, as described above, a controller may be configured to control various aspects of the illustrated cartridge 300 and testing protocols (e.g., assays) utilizing cartridge 300 and/or any components thereof. Although various cartridge components and arrangements of these components a are provided for explanatory purposes, and different shapes, amounts, and/or types of beads, particles, and/or components may be used.

In examples, the controller can execute a program that cause one or more components of the cartridge 300 to perform a series of events to by way of a non-transitory computer-readable medium having stored program instructions, including those described in further detail in connection with, at least, FIG. 2 above.

In example embodiments, each, some, or all of component reservoirs 304 may contain a solution (e.g., a buffer and/or wash solution) which may be transported via the plurality of electrodes may transport to the single substantially linear path 308 of dielectric cartridge surface. In examples, the paramagnetic, bar-coded beads may be contained in one of the component reservoirs 304 and introduced into a droplet, either in a liquid suspension or dried onto a surface of the cartridge 300 and rehydrated.

In one example, the paramagnetic, bar-coded beads may be suspended in buffer solution containing sucrose, removed from the suspension, and dried before being stored on a portion 310 of the single substantially linear path 308 of dielectric cartridge surface or in the path or paths approximate to one or more of the component reservoirs 304. In examples, the dried paramagnetic, bar-coded beads may be rehydrated with one or more solutions containing one or more components (e.g., reagents, sample, or both, among other possibilities) before being used in one or more aspects of a testing protocol (e.g., an assay). In example embodiments, once the paramagnetic, bar-coded beads are rehydrated and/or introduced into a fluidic droplet, the droplet containing paramagnetic, bar-coded beads may be transported from portion 310 to sample reservoir 302 to be mixed with a sample residing in sample reservoir (e.g., a fecal sample, urine sample, blood sample, etc.). In other example embodiments, once the paramagnetic, bar-coded beads are rehydrated and/or introduced into a fluidic droplet, the droplet containing may be combined and/or with one or more components stored in each, some, or all of component reservoirs 304, and/or the paths approximate each, some, or all of component reservoirs 304, and mixed with the paramagnetic, bar-coded beads residing on portion 310 at the portion 310.

To do so, in example embodiments, the plurality of electrodes may transport a droplet of assay components (e.g., containing antibodies, antigens, labels, reagents, and/or other binding members) from one or more assay components in the one or more component reservoirs 304 on the dielectric cartridge surface. In examples, these assay components may be introduced into a droplet along the single substantially linear path 308 of dielectric cartridge surface, after being rehydrated (e.g., in one or more component reservoirs 304, on one or more paths approximate to component reservoirs 304, or both, among other possibilities). Either way, once the assay components are introduced into the droplet, the droplet containing assay components may be transported to sample reservoir 302, the portion 310, and/or other portions of the single substantially linear path 308 of dielectric cartridge surface to be mixed with the sample and/or paramagnetic, bar-coded beads.

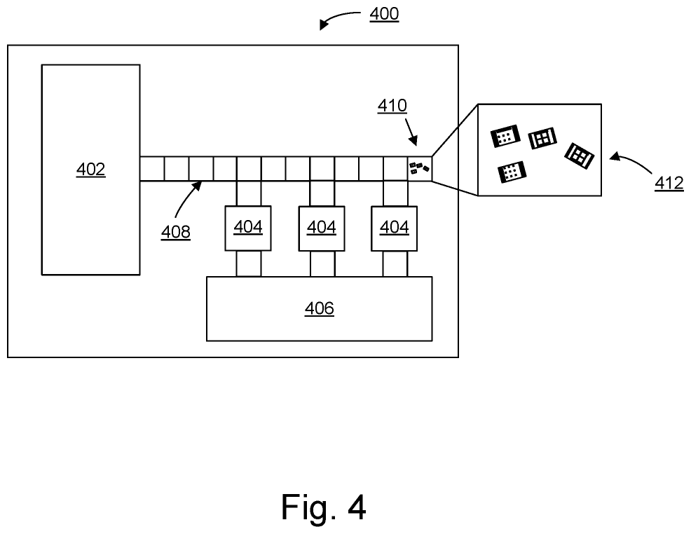

Furthermore, although sample reservoir 302 and component reservoirs 304 are illustrated as single reservoirs in FIG. 3, it should be apparent to a person of ordinary skill in the art that any, some, or all of these reservoirs may comprise multiple, separate reservoirs, each of which may contain a particular particle, components, or solution (e.g., dried paramagnetic, bar-coded beads and/or particular antibodies, antigens, labels, and/or other binding members, solutions, etc.). In other example embodiments, although the illustrated waste reservoir 306 is illustrated in FIG. 4 as being disposed on the dielectric surface of the cartridge, this reservoir could be disposed on a portion of the cartridge without dielectric properties (as no fluidic movement may be required after the bi-product liquids are transported to the waste reservoir).

Indeed, in example embodiments, each of the six illustrated component reservoirs 304 may contain a particular particle, components, or solution (e.g., one component reservoir only contains wash solution, one contains only buffer solution, one contain a first antibody, one a second antibody, one contains a particular reagent, and one contains a particular label). In a further aspect, any, some, or all of the particular particle, components, or solution may be transported from the component reservoirs 304 to the single substantially linear path 308 of dielectric cartridge surface via the plurality of electrodes, potentially after being rehydrated of hydrate on the surface. Additionally or alternatively, although specifically illustrated in FIG. 3, there may be more or less component reservoirs in cartridge 300, each with their own associated assay component and/or path on the dielectric cartridge surface.

Like FIG. 2, in example embodiments in FIG. 3, a variety of techniques can be used facilitate the mixing of the sample, the paramagnetic, bar-coded beads, and the components in and around various portions and reservoirs of cartridge 300, including sample reservoir 302 and portion 310. It should be appreciated that, as discussed in detail in the context of FIG. 2, mixing protocols can occur in a variety parts of the illustrated cartridge 300, as well as various testing protocols (including assays). As illustrated in FIG. 3, exploded view 312 provides an example view of paramagnetic, bar-coded beads being read at the portion 310, and it should be appreciated that this analysis (e.g., reading) could occur at other portions of the cartridge 300, including in the sample reservoir 302.

Additionally, in some example embodiments, the one or more components of the cartridge illustrated in FIG. 3, the controller illustrated in FIGS. 1 and 2, and/or other components of the illustrated system may provide feedback to a user/operator, including a graphical representation of a detected parameter, a test result, and/or the like, via a user interface of the controller and/or the tabletop device to provide information to the user. Other examples are possible.

For example, now referring to FIG. 4, a cartridge 400 is disclosed, which includes a sample reservoir 402, multiple component reservoirs 404, and a waste reservoir 406, all of which reside on the dielectric cartridge surface, according to an example embodiment. In this example embodiment, a plurality of electrodes and at least one magnet are disposed along various portions of dielectric cartridge surface, including along the single substantially linear path 408 that extends between sample reservoir 402 and a portion 410 of the single substantially linear path 408, and is connected to the paths on the dielectric cartridge surface that lead to component reservoirs 404, all of which terminate in waste reservoir 406. Unlike FIGS. 2 and 3, in FIG. 4, the waste reservoir 406 is not at a terminal end of the ingle substantially linear path 408. Thus, when fluids and/or other component are transported to the waste reservoir 406, they are not transported, exclusively, via the single substantially linear path 408. Instead, these waste products may be transported to the waste reservoir via any one of the illustrated paths of the multiple illustrated component reservoirs 404. In a further aspect, the plurality of electrodes and at least one magnet may be disposed under and/or around any of the illustrated sample reservoir 402, component reservoirs 404, waste reservoir 406, and/or portion 410.

In examples, the cartridge 400 and/or any components thereof may interact with a computing device, which may be implemented as a controller, and a user of the controller can use the controller to program and/or control cartridge 400 and/or any components thereof. Further, as described above, a controller may be configured to control various aspects of the illustrated cartridge 400 and testing protocols (e.g., assays) utilizing cartridge 400 and/or any components thereof. Although various cartridge components and arrangements of these components a are provided for explanatory purposes, and different shapes, amounts, and/or types of beads, particles, and/or components may be used.

In examples, the controller can execute a program that cause one or more components of the cartridge 400 to perform a series of events to by way of a non-transitory computer-readable medium having stored program instructions, including those described in further detail in connection with, at least, FIGS. 2 and 3, above.

In example embodiments, each, some, or all of component reservoirs 404 may contain a solution (e.g., a buffer and/or wash solution) which may be transported via the plurality of electrodes may transport to the single substantially linear path 408 of dielectric cartridge surface. In examples, the paramagnetic, bar-coded beads may be contained in one of the component reservoirs 404 and introduced into a droplet, either in a liquid suspension or dried onto a surface of the cartridge 400 and rehydrated.

In one example, the paramagnetic, bar-coded beads may be suspended in buffer solution containing sucrose, removed from the suspension, and dried before being stored on a portion 410 of the single substantially linear path 408 of dielectric cartridge surface or in the path or paths approximate to one or more of the component reservoirs 404. In examples, the dried paramagnetic, bar-coded beads may be rehydrated with one or more solutions containing one or more components (e.g., reagents, sample, or both, among other possibilities) before being used in one or more aspects of a testing protocol (e.g., an assay).

In example embodiments, once the paramagnetic, bar-coded beads are rehydrated and/or introduced into a fluidic droplet, the droplet containing paramagnetic, bar-coded beads may be transported from portion 410 to sample reservoir 402 to be mixed with a sample residing in sample reservoir (e.g., a fecal sample, urine sample, blood sample, etc.).

In other example embodiments, once the paramagnetic, bar-coded beads are rehydrated and/or introduced into a fluidic droplet, the droplet containing may be combined and/or with one or more components stored in each, some, or all of component reservoirs 404, and/or the paths approximate each, some, or all of component reservoirs 404, and mixed with the paramagnetic, bar-coded beads residing on portion 410 at the portion 410.

To do so, in example embodiments, the plurality of electrodes may transport a droplet of assay components (e.g., containing antibodies, antigens, labels, reagents, and/or other binding members) from one or more assay components stored in the one or more component reservoirs 404 on the dielectric cartridge surface. In examples, these assay components may be introduced into a droplet along the single substantially linear path 408 of dielectric cartridge surface, after being rehydrated (e.g., in one or more component reservoirs 404, on one or more paths approximate to component reservoirs 404, or both, among other possibilities). Either way, once the assay components are introduced into the droplet, the droplet containing components (e.g., assay components), or some combination thereof, may be transported to sample reservoir 402, the portion 410, and/or other portions of the single substantially linear path 408 of dielectric cartridge surface to be mixed with the sample, the paramagnetic, bar-coded beads, and/or the components, among other possibilities.

Furthermore, although sample reservoir 402 and component reservoirs 404 are illustrated as single reservoirs in FIG. 4, it should be apparent to a person of ordinary skill in the art that any, some, or all of these reservoirs may comprise multiple, separate reservoirs, each of which may contain a particular particle, components, or solution (e.g., dried paramagnetic, bar-coded beads and/or particular antibodies, antigens, labels, and/or other binding members, solutions, etc.). In other example embodiments, although the illustrated waste reservoir 406 is illustrated in FIG. 4 as being disposed on the dielectric surface of the cartridge, this reservoir could be disposed on a portion of the cartridge without dielectric properties (as no fluidic movement may be required after the bi-product liquids are transported to the waste reservoir).

Like FIGS. 2 and 3, in example embodiments, a variety of techniques can be used facilitate the mixing of the sample, the paramagnetic, bar-coded beads, and the components in and around various portions and reservoirs of cartridge 300, including sample reservoir 302 and portion 310. It should be appreciated that, as discussed in detail in the context of FIGS. 2 and 3, mixing protocols can occur in a variety parts of the illustrated cartridge 400, as well as various testing protocols (including assays). As illustrated in FIG. 4, exploded view 412 provides an example view of paramagnetic, bar-coded beads being read at the portion 410, and it should be appreciated that this analysis (e.g., reading) could occur at other portions of the cartridge 400, including in the sample reservoir 402.

Additionally, in some example embodiments, the one or more components of the cartridge illustrated in FIG. 4 the controller illustrated in FIGS. 1-3, and/or other components of the illustrated system may provide feedback to a user/operator, including a graphical representation of a detected parameter, a test result, and/or the like, via a user interface of the controller and/or the tabletop device to provide information to the user. Other examples are possible.

### EXAMPLE METHODS AND ASPECTS

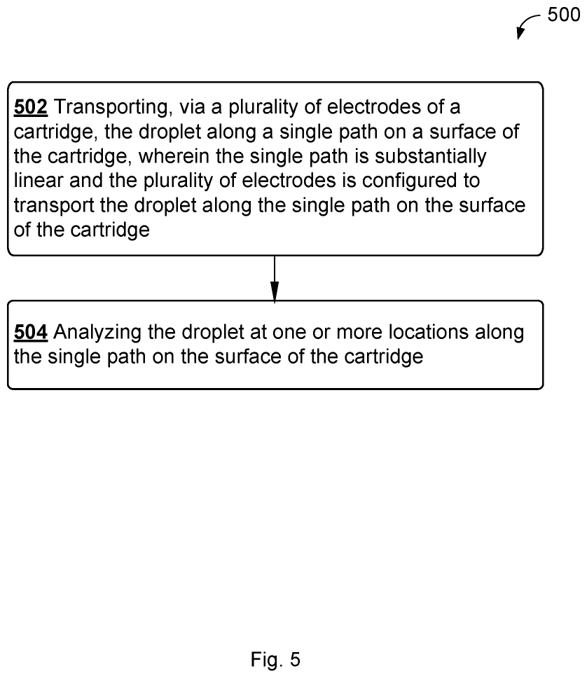

Now referring to FIG. 5, an example method of analyzing a droplet on a surface of a cartridge, wherein the droplet comprises a plurality of particles, is disclosed.

Method 500 shown in FIG. 5 presents an example of a method that could be used with the components shown in FIGS. 1-4, for example. Further, devices or systems may be used or configured to perform logical functions presented in FIG. 5. In other examples, components of the devices and/or systems may be arranged to be adapted to, capable of, or suited for performing the functions, such as when operated in a specific manner. Method 500 may include one or more operations, functions, or actions as illustrated by one or more of blocks 502-504. Although the blocks are illustrated in a sequential order, these blocks may also be performed in parallel, and/or in a different order than those described herein.

Also, the various blocks may be combined into fewer blocks, divided into additional blocks, and/or removed based upon the desired implementation.

At block 502, method 500 analyzing a droplet on a surface of a cartridge, wherein the droplet comprises a plurality of particles involves transporting, via a plurality of electrodes of the cartridge, the droplet along a single path on the surface of the cartridge, wherein the single path is substantially linear and the plurality of electrodes is configured to transport the droplet along the single path on the surface of the cartridge.

In some example embodiments, the at least one paramagnetic, bar-coded bead of the droplet comprises at least one paramagnetic, bar-coded bead. In some example embodiments, the at least one paramagnetic, bar-coded bead of the droplet comprises one or more unique bar codes. In other examples, the at least one paramagnetic, bar-coded bead of the droplet comprises at least one non-spherical, paramagnetic, bar-coded bead. In some examples, the at least one paramagnetic, bar-coded bead of the droplet is between approximately 0.1 and 100 microns in size. In some examples, the droplet further comprises a solution for washing the plurality of particles of the droplet. In some examples, the droplet further comprises a read buffer solution.

In some examples, the single path on the surface of the cartridge comprises a dielectric material, and transporting, via a plurality of electrodes of the cartridge, the droplet along a single path on the surface of the cartridge comprises applying an electric current to the electrodes of the cartridge. In some examples, the electrical current comprises a direct electric current. In some examples, the electrical current comprises an alternating electric current.

In some example, the single path on the surface of the cartridge further comprises a sample reservoir and a waste reservoir.

At block 504, method 500 involves analyzing the droplet at one or more locations along the single path on the surface of the cartridge.

In examples, analyzing the droplet at one or more locations along the single path on the surface of the cartridge comprises analyzing the droplet in the sample reservoir.

In some examples, method 500 further involves immobilizing, via at least one magnet of the cartridge, the droplet at a particular location along the single path on the surface of the cartridge, wherein the at least one magnet is configured to immobilize the droplet along the single path on the surface of the cartridge. In some examples, immobilizing, via at least one magnet of the cartridge, the droplet at a particular location along the single path on the surface of the cartridge, comprises immobilizing the at least one paramagnetic, bar-coded bead of the droplet. In some examples, analyzing the droplet at one or more locations along the single path on the surface of the cartridge comprises analyzing the droplet while the droplet is immobilized at a particular location along the single path on the surface of the cartridge.

Additionally, in some examples, analyzing the droplet at one or more locations along the single path on the surface of the cartridge comprises performing one or more assay procedures on the droplet at the one or more locations along the single path on the surface of the cartridge, and wherein, during the one or more assay procedures, determining a parameter of the droplet. In some examples, determining a parameter of the droplet comprises identifying a particular feature of the plurality of particles.

In some examples, analyzing wherein analyzing the droplet at one or more locations along the single path on the surface of the cartridge comprises generating an image of the droplet at the one or more locations along the single path on the surface of the cartridge, wherein the image comprises an image of the plurality of particles and, based on the generated image, determining a parameter of the droplet. In some examples, determining a parameter of the droplet comprises comparing the generated image of the droplet to a previously generated image of the droplet. In some examples, analyzing the droplet further comprises, while generating an image of the droplet at the one or more locations along the single path on the surface of the cartridge, applying an ultraviolet light to the droplet. In some examples, analyzing the droplet comprises generating a composite image of the droplet on the surface of the cartridge, wherein the composite image comprises a plurality of images of the at least one paramagnetic, bar-coded bead of the droplet and, based on the generated composite image, determining a parameter of the droplet. In some examples, the method 500 includes transmitting instructions that cause a graphical user interface to display a graphical representation of the determined parameter of the droplet.

In some examples, analyzing the droplet at one or more locations along the single path on the surface of the cartridge comprises performing a plurality of assay procedures on the droplet at the one or more locations along the single path on the surface of the cartridge, and wherein, during the one or more assay procedures, determining a presence of one or more analytes adhered to the at least one paramagnetic, barcoded bead of the droplet.

In one aspect, a non-transitory computer-readable medium, having stored thereon program instructions that, upon execution by a controller, cause a controller to perform a set of operations comprising transporting, via a plurality of electrodes of a cartridge, a droplet along a single path on a surface of the cartridge, wherein the droplet comprises a plurality of particle, and wherein the single path is substantially linear and the plurality of electrodes is configured to transport the droplet along the single path on the surface of the cartridge and analyzing the droplet at one or more locations along the single path on the surface of the cartridge, is disclosed.

The singular forms of the articles “a,” “an,” and “the” include plural references unless the context clearly indicates otherwise. For example, the term “a compound” or “at least one compound” can include a plurality of compounds, including mixtures thereof.

Various aspects and embodiments have been disclosed herein, but other aspects and embodiments will certainly be apparent to those skilled in the art. Additionally, the various aspects and embodiments disclosed herein are provided for explanatory purposes and are not intended to be limiting, with the true scope being indicated by the following claims.

What is claimed is:

1. A method for analyzing a droplet on a surface of a cartridge, wherein the droplet comprises a plurality of particles, the method comprising:
transporting, via a plurality of electrodes of the cartridge, the droplet along a single path on the surface of the cartridge, wherein the single path is substantially linear and the plurality of electrodes is configured to transport the droplet along the single path on the surface of the cartridge; and
analyzing the droplet at one or more locations along the single path on the surface of the cartridge.

2. The method of claim 1, wherein the plurality of particles comprises at least one paramagnetic, bar-coded bead.

3. The method of claim 2, wherein the at least one paramagnetic, bar-coded bead comprises one or more unique bar codes.

4. The method of claim 2, wherein the at least one paramagnetic, bar-coded bead comprises at least one non-spherical, paramagnetic, bar-coded bead.

5. The method of claim 2, wherein the at least one paramagnetic, bar-coded bead is between approximately 0.1 to 100 microns in size.

6. The method of claim 1, wherein single path on the surface of the cartridge comprises a dielectric material, and wherein transporting, via a plurality of electrodes of the cartridge, the droplet on the surface of the cartridge comprises applying an electric current to the electrodes of the cartridge.

7. The method of claim 6, wherein the electric current comprises a direct electric current.

8. The method of claim 6, wherein the electric current comprises an alternating electric current.

9. The method of claim 1, wherein the single path on the surface of the cartridge further comprises a sample reservoir and a waste reservoir.

10. The method of claim 9, wherein analyzing the droplet at one or more locations along the single path on the surface of the cartridge comprises analyzing the droplet in the sample reservoir.

11. The method of claim 1, wherein the method further comprises immobilizing, via at least one magnet of the cartridge, the droplet at a particular location along the single path on the surface of the cartridge, wherein the at least one magnet is configured to immobilize the droplet along the single path on the surface of the cartridge.

12. The method of claim 11, wherein immobilizing, via at least one magnet of the cartridge, the droplet at a particular location along the single path on the surface of the cartridge, comprises immobilizing the at least one paramagnetic, bar-coded bead of the droplet.

13. The method of claim 11, wherein analyzing the droplet at one or more locations along the single path on the surface of the cartridge comprises analyzing the droplet while the droplet is immobilized at a particular location along the single path on the surface of the cartridge.

14. The method of claim 11, wherein the method further comprises transporting along the single path an additional droplet, wherein the additional droplet comprises at least one of a sample and a reagent, and wherein the additional droplet interacts with the immobilized droplet.

15. The method of claim 14, wherein the additional droplet is transported along the single path such that the additional droplet interacts with the immobilized droplet more than once.

16. The method of claim 15 wherein during the analyzing the droplet at one or more locations along the single path on the surface of the cartridge, an increased analysis signal is produced due to the more than one interaction between the droplet and at least one of the sample and the reagent of the additional droplet.

17. The method of claim 11, wherein immobilizing, via at least one magnet of the cartridge, the droplet at a particular location along the single path on the surface of the cartridge, comprises immobilizing the at least one paramagnetic, bar-coded bead of the droplet and wherein the method further comprises transporting fluid contained in the droplet to a waste reservoir.

18. The method of claim 17, wherein the method further comprises transporting along the single path an additional droplet, wherein the additional droplet comprises at least one of a sample and a reagent, and wherein the additional droplet interacts with the immobilized at least one paramagnetic, bar-coded bead.

19. The method of claim 18, wherein the additional droplet is transported along the single path such that the additional droplet interacts with the immobilized at least one paramagnetic, bar-coded bead more than once.

20. The method of claim 19 wherein the method further comprises analysing the at least one paramagnetic, bar-coded bead, and wherein during the analyzing the at least one paramagnetic, bar-coded bead at one or more locations along the single path on the surface of the cartridge, an increased analysis signal is produced due to the more than one interaction between the at least one paramagnetic, bar-coded bead and at least one of the sample and the reagent of the additional droplet.

21. The method of claim 1, wherein analyzing the droplet at one or more locations along the single path on the surface of the cartridge comprises performing one or more assay procedures on the droplet at the one or more locations along the single path on the surface of the cartridge, and wherein, during the one or more assay procedures, determining a parameter of the droplet.

22. The method of claim 21, wherein determining a parameter of the droplet comprises identifying a particular feature of the plurality of particles.

23. The method of claim 22, wherein analyzing the droplet at one or more locations along the single path on the surface of the cartridge comprises generating an image of the droplet at the one or more locations along the single path on the surface of the cartridge, wherein the image comprises an image of the plurality of particles; and
based on the generated image, determining a parameter of the droplet.

24. The method of claim 23, wherein determining a parameter of the droplet comprises comparing the generated image of the droplet to a previously generated image of the droplet.

25. The method of claim 23, wherein analyzing the droplet further comprises, while generating an image of the droplet at the one or more locations along the single path on the surface of the cartridge, applying an ultraviolet light to the droplet.

26. The method of claim 21, wherein the method further comprises:
transmitting instructions that cause a graphical user interface to display a graphical representation of the determined parameter of the droplet.

27. The method of claim 1, wherein analyzing the droplet at one or more locations along the single path on the surface of the cartridge comprises performing a plurality of assay procedures on the droplet at the one or more locations along the single path on the surface of the cartridge, and wherein, during the plurality of assay procedures, determining a presence of one or more analytes adhered to the at least one paramagnetic, barcoded bead of the droplet.

28. The method of claim 1, wherein the droplet further comprises a solution for washing the plurality of particles of the droplet.

29. The method of claim 1, wherein the droplet further comprises a read buffer solution.

30. A non-transitory computer-readable medium, having stored thereon program instructions that, upon execution by a controller, cause a controller to perform a set of operations comprising:
transporting, via a plurality of electrodes of a cartridge, a droplet along a single path on a surface of the cartridge, wherein the droplet comprises a plurality of particle, and wherein the single path is substantially linear and the plurality of electrodes is configured to transport the droplet along the single path on the surface of the cartridge; and
analyzing the droplet at one or more locations along the single path on the surface of the cartridge.

31. A cartridge comprising:
a plurality of electrodes;
a single path for transporting a droplet on a surface of the cartridge, wherein the single path is substantially linear and the plurality of electrodes is configured to transport a droplet along the single path on the surface of the cartridge, and wherein the droplet comprises a plurality of particle; and
one or more locations for analyzing the droplet along the single path on the surface of the cartridge.
